(19) United States
(12) Patent Application Publication
(10) Pub. No.: US 2010/0231410 A1
(43) Pub. Date: Sep. 16, 2010

(54) Device and Method for Multi-Dimensional Location of Target Objects, In Particular Rfid Transponders

(76) Inventors: Claus Seisenberger, Neufrannhofen (DE); Leif Wiebking, Munchen (DE); Joachim Würker, Freising (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/223,085

(22) PCT Filed: Jan. 5, 2007
(86) PCT No.: PCT/EP2007/050109

§ 371 Date: Jul. 22, 2008

(30) Foreign Application Priority Data
Jan. 27, 2006 (DE) 10 2006 004 023.6

(51) Int. Cl. G08B 5/22

(52) U.S. Cl. 340/825.49

(57) ABSTRACT

A radio-based system and a method for multi-dimensional location of a target object are provided. A target object may be, in particular, an RFID transponder. In this context, a base signal is emitted by a base station and is sent back by a back scatter transponder. A distance between the base station and the transponder is determined by means of a frequency spacing ΔF between two maximum values in the base band of the spectrum of a base signal, transmitted with a simultaneously received response signal superimposed on it, from an antenna of the base station. Phase evaluation is carried out in order to calculate a target deviation angle α_{z}. Depending on the number and arrangement of the antennas of the base station, a unidimensional, two-dimensional or three-dimensional locating process can be carried out.

### CROSS REFERENCE TO RELATED APPLICATIONS

This application is the US National Stage of International Application No. PCT/EP2007/050109, filed Jan. 5, 2007 and claims the benefit thereof. The International Application claims the benefits of German application No. 10 2006 004 023.6 filed Jan. 27, 2006 DE, both of the applications are incorporated by reference herein in their entirety.

### FIELD OF INVENTION

The present invention relates to a radio-based system for the multi-dimensional location of a target object, in particular an RFID transponder, in particular based on the principle of modulated backscatter with a base station with a plurality of antennas for transmitting base signals and/or receiving response signals, a target object for receiving the base signals and for emitting response signals.

### BACKGROUND OF INVENTION

According to the prior art there are no RFID systems for the multi-dimensional location of RFID transponders. In the fields of logistics, material tracking, person tracking, etc. there is a great demand for such systems, which are able not just to identify but also to determine the local position of goods and items and to track these. This can be achieved in particular with locatable RFID tags attached to the goods.

According to the prior art different approaches are used for the one-dimensional location of RFID transponders.

A first option is to determine the distance to RFID transponders using location systems based on field strength. The problems associated with multipath propagation means that this method is only accurate within a range of several meters.

According to a second solution location systems operate according to SDMA methods. The distance to a transponder is obtained by way of the orientation of a transmit/receive antenna with a high bundling capacity, at which the maximum receive level value occurs.

According to a third solution systems for one-dimensional distance measurement of a backscatter transponder are used, which are based on the propagation time measurement of a radio signal reflected after modulation by the transponder.

### SUMMARY OF INVENTION

The object of the present invention is to provide a device and method for the multi-dimensional location of target objects, in particular of modulated backscatter RFID transponders.

The object is achieved by a device and a method as claimed in the independent claims. Further advantageous embodiments will emerge from the dependent claims.

Radio-based systems are all technical systems, which use electromagnetic waves that can be transmitted and received by antennas. They include for example radar waves, which are used for example in a range from 500 MHz to 100 GHz or waves used for RFID (Radio Frequency Identification), which are used for example in a range from 800 MHz to 2.4 GHz. Base signals and response signals are electromagnetic waves of this type.

One-dimensional detection of the distance r_{z} from the base station to the target object takes place as does detection of at least one target object deviation angle α_{z}.

A target object deviation angle α_{z} is an angle in a horizontal x-, y-plane or a vertical y-, z-plane and in the case of the horizontal plane between a main action direction of the base station on the y-axis and a projection of the line from the base station to the target object into the horizontal plane or in the case of the vertical plane between the main action direction of the base station on the y-axis and a projection of the line from the base station to the target object into the vertical plane. A target object deviation angle α_{z} in the horizontal plane is used to determine the x- and y-coordinates. A target object deviation angle α_{z} in the vertical plane is used to determine the z-coordinates. The respective determination operations are carried out simply using trigonometry.

With the radio-based system it is possible to locate target objects, in particular transponders, which operate according to the modulated backscatter principle, with the aid of a frequency-modulated radio signal transmitted by the base station. The one-dimensional distance measurement is effected by way of a measurement of the propagation time of the electromagnetic radio signal from the transmitter by way of the transponder back to the receiver. The two or three-dimensional location is achieved with a suitable antenna arrangement using a novel phase evaluation. From the measurement of the phase information of the signal reflected by the transponder occurring at the individual antennas of the base station it is possible to conclude the respective deviation angle α_{z} of the transponder. The antennas are hereby arranged with the interval dⱼ and can be housed in a single structural unit due to their spatial proximity. Only one base station is necessary for the two or three-dimensional location. The detected distance value is used to determine the exact spatial position of the transponder. The first and second facility can be integrated in the base station for example. It is likewise possible for the first and second facility to be combined in one.

The distance r_{z} of a target object or target reflector located in an observation region of a radar receiver is determined for example from a measurement of the signal propagation time t_{L} from the transmitter to the reflector and back to the receiver. The transmit signal used can for example be a high-frequency FMCW signal with linear frequency modulation. The distance r_{z} and a target object deviation angle α_{z} can be used to calculate x- and y-coordinates by means of trigonometry.

If the target object deviation angle α_{z} is detected in a vertical plane, it is possible to determine the elevation or z-coordinate.

According to one advantageous embodiment, to distinguish a transponder to be located unambiguously from other interfering targets in the radar or radio-based system detection region, the principle known as modulated backscatter of the modulated base signal is applied. A modulation is hereby impressed on the signal reflected by the transponder, by varying the backscatter cross-section or the reflection response of the transponder antenna periodically with a modulation frequency f_{mod}.

According to a further advantageous embodiment the first facility for determining the distance r_{z} can be used to determine a frequency interval ΔF between two maximum values in the baseband of the spectrum of a base signal transmitted with a simultaneously received response signal superimposed on it. The principle known as modulated backscatter is applied. The base signal can likewise be modulated. A modulation is impressed on the signal reflected by the transponder. The transponder modulation causes the signal components in the spectrum originating from the transponder to be displaced to a higher frequency band, by (f_{mod}). Two maximum values result above and below the modulation frequency f_{mod} of the transponder, their mutual frequency interval ΔF being proportional to the distance r_{z} between the transponder and the base station.

According to a further advantageous embodiment the second facility can be used to determine a distance rᵢ between the target object and an antenna using maximum value phase differences. A maximum value phase difference is the difference between the phase values at the frequency points where the above-mentioned maximum values occur. A maximum detection algorithm is used to determine the frequency interval ΔF of the two maximum values occurring around the modulation frequency f_{mod}. The distance to the transponder can be calculated from the determined frequency difference ΔF according to the following formula:

$${r}_{z} = \frac{Δ F \cdot T \cdot {c}_{0}}{4 \cdot B} \qquad ( 1 )$$

Here c₀ is the speed of light, T the ramp period and B the frequency swing of the FMCW transmit signal (frequency modulated continuous wave).

According to a further advantageous embodiment the second facility can be used to determine distance differences Δrᵢ between adjacent antennas and the target object or transponder based respectively on a difference in maximum value phase differences. The high level of sensitivity of the phase gradient curve means that the smallest distance differences Δrᵢ can be resolved over a phase evaluation. This characteristic is used to determine a path difference Δrᵢ occurring between antennas and therefore the target deviation angle α_{z}.

According to a further advantageous embodiment the second facility can be used to determine at least one target object deviation angle α_{z} based on the ratio of distance differences Δrᵢ between two adjacent antennas to their intervals dⱼ. The arc sine of this ratio is hereby equal to the target object deviation angle α_{z}. Finally it is possible to calculate the x- and y-positions of the target object from the angle α_{z} and the distance r_{z}, for example using the second facility:

x_{z}=sin α_{z}·r_{z}

y_{z}=cos α_{z}·r_{z} (2)

According to a further advantageous embodiment the distance r_{z} between the base station and the target object is essentially greater than mutual intervals dⱼ of adjacent antennas in relation to one another. For a two-dimensional position determination the distance from the target object is advantageously much greater than the mutual interval of the antennas in relation to one another, in other words r_{z}>>dⱼ. It can thus be approximately assumed that the beams reflected from the target object to the antennas run parallel to one another.

According to a further advantageous embodiment the interval dⱼ of adjacent antennas is small. This is advantageous in particular when two antennas are used. Since a phase difference in the event of a distance change of Δr=λ/4 tops an angular range of φ, the maximum value phase difference pattern is ambiguous. This ambiguity means that an unambiguous distance measurement is only possible in the region of a ¼ wavelength. λ is the wavelength of the transmit signal here. In order to be able to detect the largest possible angular range unambiguously, the antenna interval dⱼ must be selected to be correspondingly small, and be even smaller, the shorter the wavelength λ.

According to a further advantageous embodiment where more than two antennas are used, the differences between the intervals dⱼ of adjacent antennas is small and ≠0. It is thus possible to extend the unambiguous range for determining the target object deviation angle α_{z}. Where three antennas are used, it is particularly advantageous to adjust the differential interval of the two antenna pairs. This differential interval can be selected to be as small as required, regardless of antenna dimensions. With this embodiment it is possible to adjust the angular range for target location to any value between ±90°.

According to a further advantageous embodiment the antennas are arranged along a horizontal line or along a vertical line. This allows three-dimensional location. It is possible to determine the azimuth one the one hand and the elevation of a target object on the other hand. The x-, y- and z-coordinates can be calculated together with the measured distance. The use of five antennas is particularly advantageous, as outlay is then limited.

According to a further advantageous embodiment the target objects are transponders, RFID tags or radio interrogation sensors. The radio-based system can thus be used in a versatile manner.

According to a further advantageous embodiment the target objects are passive or semi-passive. This means that it is advantageously not necessary to use an amplifier in the target object.

According to the present invention a method is also claimed for using a radio-based system for the multi-dimensional location of a target object, in particular an RFID transponder.

### BRIEF DESCRIPTION OF THE DRAWINGS

The invention is described in more detail below with reference to exemplary embodiments in conjunction with the figures, in which:

FIG. 1 shows an exemplary embodiment of a radio-based system for two-dimensional location;

FIG. 2a shows a first exemplary embodiment of a one-dimensional distance measurement;

FIG. 2b shows a baseband of the spectrum for the first exemplary embodiment of a one-dimensional distance measurement;

FIG. 3 shows a second exemplary embodiment of a one-dimensional distance measurement;

FIG. 4 shows a graphic representation of the baseband of the spectrum according to the second exemplary embodiment for one-dimensional distance measurement;

FIG. 5 shows a first exemplary embodiment of a two-dimensional position determination;

FIG. 6 shows the comparison of the phase difference over the distance range of a wavelength;

FIG. 7 shows the system components according to the exemplary embodiment in FIG. 5;

FIG. 8 shows two representations of the dependency of an unambiguous range on the interval of two antennas in relation to one another;

FIG. 9 shows a further exemplary embodiment for two-dimensional position determination with extended unambiguous range;

FIG. 10 shows an exemplary embodiment for three-dimensional location;

FIG. 11 shows a representation of the position of a target object in three-dimensional space.

### DETAILED DESCRIPTION OF INVENTION

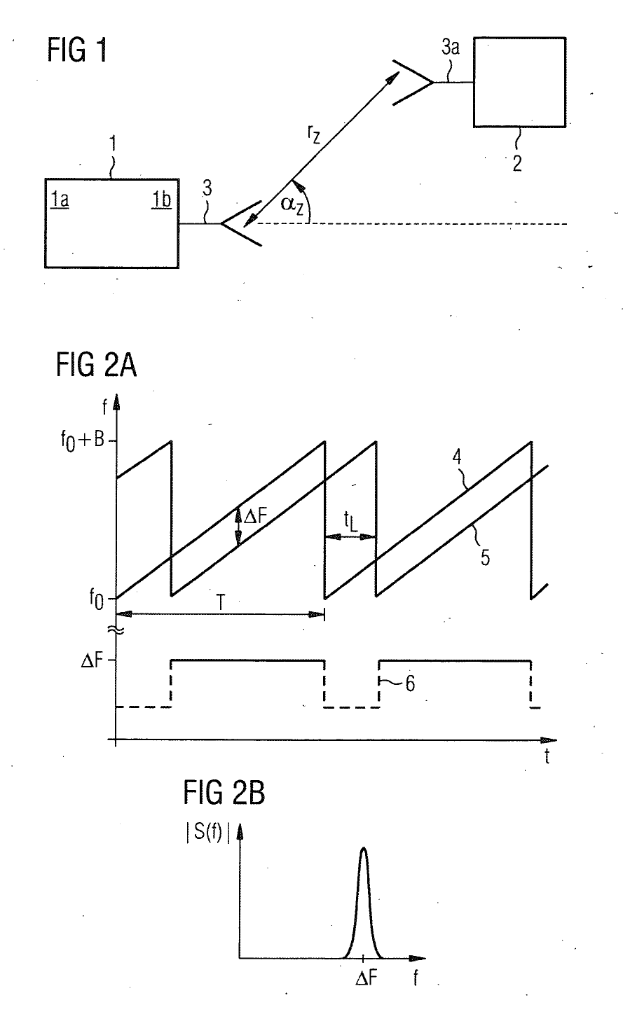

FIG. 1 shows an example of the structure and measurement variables of a two-dimensional location system. Here 1 designates a base station, 2 a target object, for example a transponder. The distance between the base station 1 and the target object 2 is shown as r_{z}. The target deviation angle α_{z} is also shown. A transponder 2 is used as the target object 2 in the following. The transponders 2 to be located can be passive, i.e. operate with a field supply without their own power supply. They can likewise be semi-passive, i.e. they are provided with their own battery or an accumulator. One, two or three-dimensional location is possible, depending on the number and arrangement of the antennas 3 in the base station 1. To determine phase information the signal reflected by the transponder 2 can be evaluated sequentially or even in a parallel manner by the individual antennas 3. The antennas 3 can also be arranged as an array. Positioning can likewise be in the form of a number of remote antennas. The transponder 2 can have an antenna 3a. A first facility 1a for distance determination and a facility 1b for angle determination can be integrated in the base station 1.

The following advantages result from the inventive position determination of target objects. It is possible to locate RFID tags. It is likewise possible to locate passive or semi-passive radio-interrogatable sensors. Two or three-dimensional location can take place in a single read device, as the antennas 3 can be housed in a compact structural unit. This means that portable manual reading devices can be provided for location purposes. When using passive and semi-passive RFID tags the energy outlay in the transponder 2 is very low, as no active, amplifying modulation methods are used. Similarly the data stream from RFID tags can be used for location purposes. This means that no additional hardware is necessary on the RFID tags. Similarly standard RFID transponders 2 can advantageously be used, which operate according to the modulated backscatter principle.

FIG. 2 shows a first exemplary embodiment of a one-dimensional distance measurement. A device and method for radio-based location in particular of RFID tags are based in particular on radar technology. A frequency-modulated electromagnetic transmit signal is transmitted from the base station 1. The distance to a target object 2 or target reflector located in the observation region of the base station 1 or radar receiver is determined from a measurement of the signal propagation time t_{L} from the transmitter to the reflector and back to the receiver. The transmit signal used is for example a high-frequency FMCW signal with linear frequency modulation.

From the frequency difference between the currently transmitted and received signal it is possible to determine the signal propagation time t_{L} and therefore the distance to the reflector. Evaluation of the frequency difference, which is proportional to the distance to the target object 2, takes place in the frequency range. In the baseband according to FIG. 2b of the spectrum a signal peak results at the frequency corresponding to the frequency difference. According to FIG. 2a 4 designates the transmit signal, 5 the receive signal and 6 the differential frequency signal. The transmit signal 4 can likewise be designated as the base signal 4 and the receive signal 5 as the response signal 5. ΔF designates the frequency difference, f₀ the frequency of the transmit signals 4, T the ramp period and B the frequency swing of the FMCW transmit signal 4. The signal propagation time is shown as t_{L}. FIG. 2b shows the signal peak or maximum at the frequency corresponding to the frequency difference ΔF.

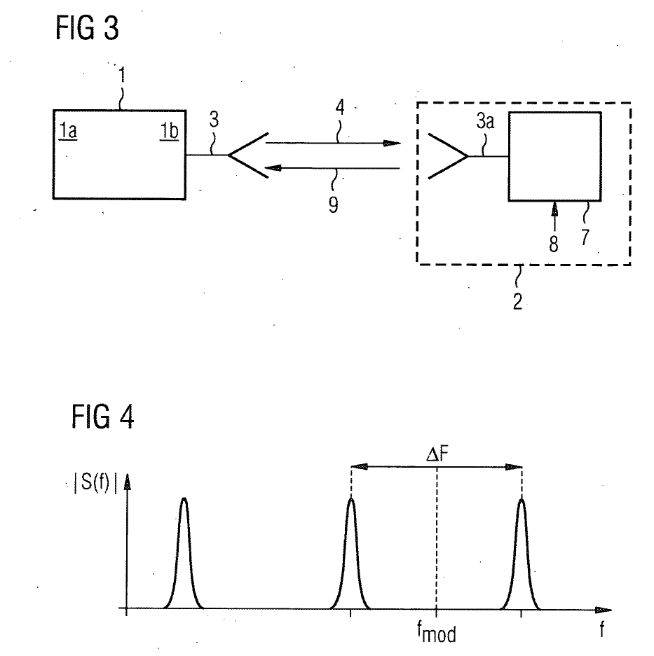

FIG. 3 shows a base station 1 and an antenna 3, by way of which a transmit signal/base signal 4 is sent to a transponder 2. The transponder 2 has a modulator 7, which is modulated by means of a modulation signal 8. The transponder 3 also has an antenna 3a. The transponder 2 transmits a receive signal 5 or a response signal 5 back to the base station 1. The response signal 5 here is a modulated reflection signal 9. To distinguish a transponder 2 to be located unambiguously from other interfering targets in the detection range of the radio-based system or the radar, a principle known as modulated backscatter is applied. A modulation is hereby impressed on the signal reflected by the transponder 2 by means of a modulation signal 8, by varying the backscatter cross-section or the reflection response of the transponder antenna 3a periodically with the modulation frequency f_{mod}. Modulation can be active or passive but active execution, in other words active amplification of the signal in the transponder 2, is not necessary. The principle of modulated backscatter is extremely energy-efficient, so it is excellently suited to use in field-supplied RFID transponders 2. The modulation method used can be amplitude or phase modulation. For multi-dimensional location determination the use of transponders 2 based on modulated backscatter is particularly advantageous. The transponders 2 used here can be passive. In this instance a modulator 7 is supplied from the radio field. The transponder 2 therefore does not have to have its own energy source, such as a battery or accumulator. Unamplified backscatter takes place. The use of semi-passive transponders is also possible. Here a modulator 7 is supplied with an energy source integrated on a transponder 2. Unamplified backscatter likewise takes place. Active transponders 2 are a further embodiment. According to this embodiment an energy source is present on the transponder 2 for amplifiers and modulators 7. This means that the base signal 4 transmitted by the base station 1 is transmitted back amplified or a response signal 5 is generated and transmitted.

Modulation causes the signal components in the spectrum originating from the transponder 2 to be displaced to a higher frequency band (by f_{mod}).

FIG. 4 shows an example of the spectrum of relevance for distance evaluation. Two maximum values result above and below the modulation frequency f_{mod} of the transponder 2, their mutual frequency interval ΔF being proportional to the distance r_{z} between the transponder 2 and the base station 1. Signal components, which originate from non-modulating interfering reflectors, are mixed into the baseband. A bandpass can be used to filter out the signal components of relevance to the determination of the distance to the transponder 2. This makes it possible to distinguish between the signal reflected by the transponder 2 and signals which originate from other non-modulating reflectors. One option for evaluating distance information is provided by digital signal processing. First a Fourier transformation (for example FFT) is used to calculate the spectrum, it being possible to apply methods such as weighting the signal with a window function and zero padding to optimize the evaluation. A maximum value detection algorithm is used to determine the frequency interval ΔF of the two maximum values occurring around the modulation frequency f_{mod}. The distance to the transponder can be determined from the determined frequency difference ΔF according to the following formula:

$${r}_{z} = \frac{Δ F \cdot T \cdot {c}_{0}}{4 \cdot B} \qquad ( 1 )$$

Here c₀ designates the speed of light, T the ramp period and B the frequency swing of the FMCW transmit signal.

FIG. 5 shows a first exemplary embodiment of a two-dimensional position determination using a read device. For a two-dimensional position determination two antennas 3 arranged adjacent to each other in a parallel manner at an interval d are used, being able to be activated respectively one after the other by the base station 1. An advantageous phase evaluation method makes it possible to evaluate the propagation time difference between the signals from the transmitter 1 to the transponder 2 and back to the respective antenna 3 and from this to conclude the target deviation angle α_{z} of the transponder 2. From the distance value r_{z} determined above it is therefore possible to determine the x- and y-position of the transponder 2.

If the distance to the target object 2 is much greater than the mutual interval of the antennas in relation to one another, in other words r_{z}>>d, it can be approximately assumed that the beams reflected by the target object 2 to the two antennas run parallel to one another. This simplification is illustrated in FIG. 5.

The angle α_{z} to the target object 2 can be determined from the distance difference Δr₁₂=r₁−r₂ between the two beam paths:

$$sin {α}_{z} = \frac{{Δ}_{12}^{r}}{d} \\ {α}_{z} = arcsin ( \frac{{Δ}_{12}^{r}}{d} ) \qquad ( 3 )$$

Finally it is possible to calculate the x- and y-position of the target object from the angle α_{z} and the distance r_{z}:

x_{z}=sin α_{z}·r_{z}

y_{z}=cos α_{z}·r_{z} (2)

The phase of the signals received by both antennas is used to determine the distance difference Δr₁₂.

For one-dimensional measurement of the distance r_{z} only the frequency interval ΔF of the two maximum values detected in the spectrum is used. For two-dimensional position determination and therefore to determine the target object deviation angle α_{z} the phase values at the points of the two maximum values in the spectrum are advantageously evaluated. To this end the phase is determined at the frequency points, at which the maximum values occur and their difference is formed:

Δφ=φ_{Maximum,right}−φ_{Maximum,left} (4)

According to the following formula the determined phase difference Δφ is:

$$Δϕ ( r ) = \frac{2 π}{λ / 4} \cdot r \qquad ( 5 )$$

proportional to the distance of the transponder 2 from the base station 1. λ here designates the wavelength of the transmit signal.

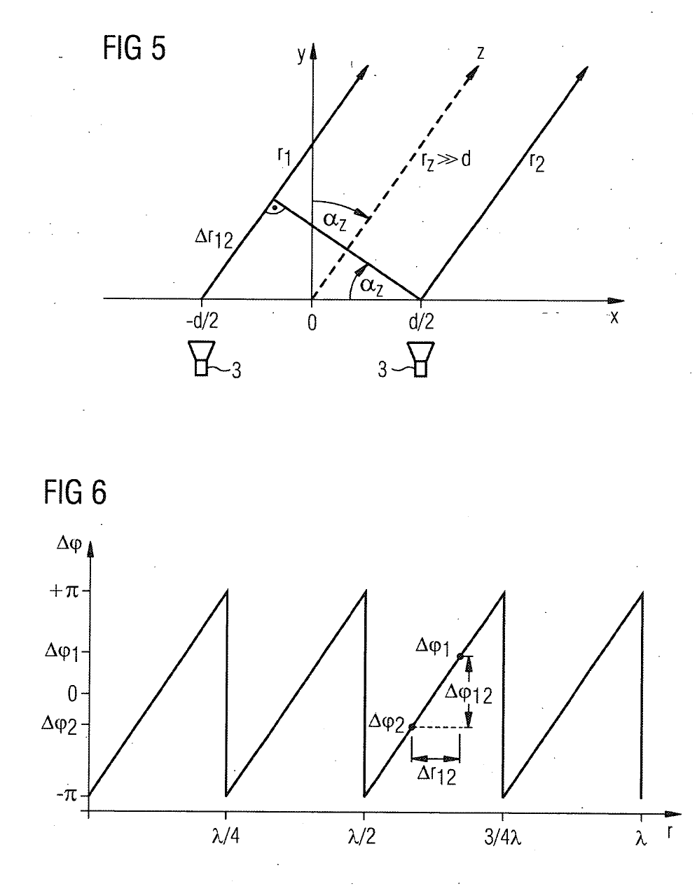

FIG. 6 shows the pattern of the phase difference Δφ over the distance range of a wavelength λ. The phase difference Δφ tops an angular range of 2π, with the distance change of Δr=λ/4. This ambiguity of the maximum value phase difference pattern means that unambiguous distance measurement is only possible in the region of a quarter wavelength. However the high level of sensitivity of the phase gradient curve means that the smallest distance differences can be resolved over a phase evaluation. This characteristic is used to determine the path difference Δr₁₂ occurring between the two antennas 3 and thus the target deviation angle α_{z} of the transponder 2.

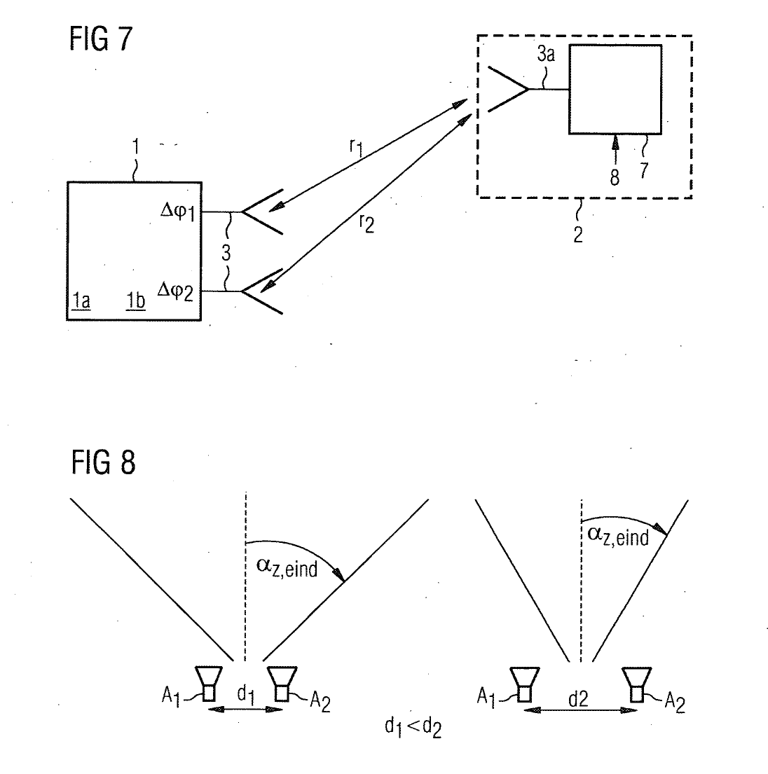

FIG. 7 shows a radio-based system with a base station 1, which uses two antennas 3. A target object 2 or transponder 2 is once again shown, having a modulator 7 modulated by means of a modulation signal 8 and an antenna 3a. r₁ and r₂ show the respective intervals between the two antennas 3 of the base station 1 and the antenna 3a of the transponder 2.

The following procedure is used to determine the target deviation angle α_{z}:

The phase difference between the detected maximum values of the first and second antennas 3 of the base station 1 respectively is first determined:

$${Δϕ}_{1} = \frac{2 π}{λ / 4} \cdot {r}_{1} \\ {Δϕ}_{2} = \frac{2 π}{λ / 4} \cdot {r}_{2} \qquad ( 6 )$$

It is not necessary for the two antenna signals to be evaluated simultaneously or phase-coherently to determine their mutual phase relation. In contrast to the phase monopulse method the two antenna signals can be transmitted and received sequentially, separately one after the other. The distance difference Δr₁₂ can now be determined with a high level of accuracy from the difference between the two maximum value phase differences Δφ₁₂=Δφ₁−Δφ₂:

$$Δ {r}_{12} = {r}_{1} - {r}_{2} = ( {Δϕ}_{1} - {Δϕ}_{2} ) \cdot \frac{λ / 4}{2 π} \qquad ( 7 )$$

The target deviation angle α_{z} of the transponder 2 can thus be calculated according to the following formula:

$${α}_{z} = arcsin ( \frac{Δ {r}_{12}}{d} ) = arcsin ( \frac{λ / 4}{2 π \cdot d} \cdot {Δϕ}_{12} ) \qquad ( 8 )$$

The periodicity of the phase gradient curve with 2π means that an unambiguous angle measurement is only possible in the region Δφ₁₂=±φ. The unambiguously detectable angular range α_{z,end} then results as follows:

$${α}_{z , end} = \pm arcsin ( \frac{λ}{8 \cdot d} ) \qquad ( 9 )$$

In order to be able to detect the biggest possible angular range unambiguously the antenna interval d must be selected to be correspondingly small, and be even smaller, the shorter the wavelength λ. This relationship is shown in FIG. 8.

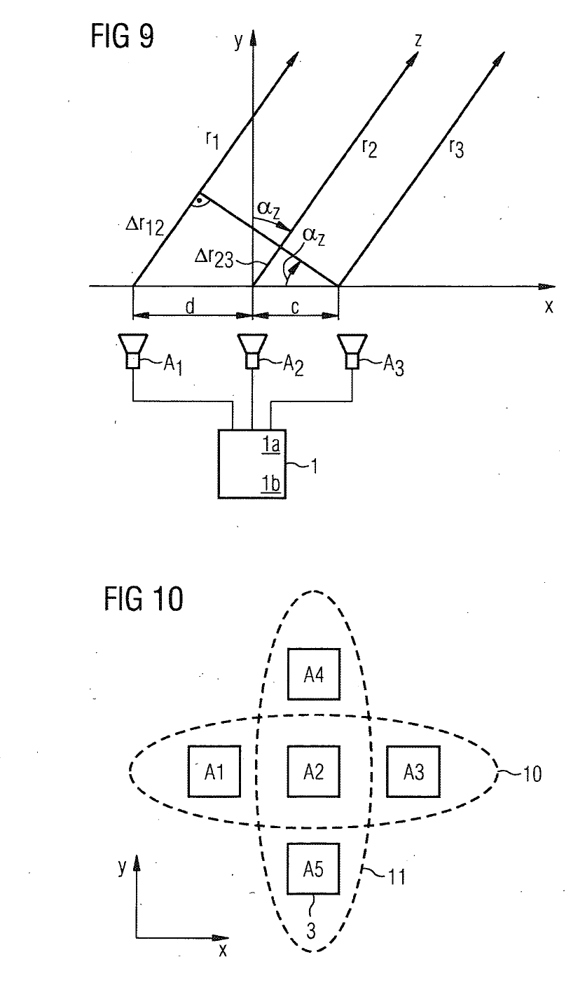

The structural dimensions of antennas 3 mean that small antenna intervals are only possible to a limited extent. Therefore the unambiguous angle measurement range is correspondingly limited. This means that it is necessary to extend the unambiguous range in another manner. The unambiguous range can advantageously be extended by means of an arrangement of three parallel antennas 3 aligned adjacent to each other. FIG. 9 shows a corresponding arrangement of the three antennas 3. It should be noted that the interval from antenna A₁ to antenna A₂ is selected so that it is greater or smaller than the interval from antenna A₂ to A₃. In other words d≠c. The base station 1 again measures the phase differences of the detected maximum values with the respective antenna A₁, A₂, A₃:

$$Δ {ϕ}_{1} = \frac{2 π}{λ / 4} \cdot {r}_{1} \\ {Δϕ}_{2} = \frac{2 π}{λ / 4} \cdot {r}_{2} \\ {Δϕ}_{3} = \frac{2 π}{λ / 4} \cdot {r}_{3} \qquad ( 10 )$$

If the difference is formed between the maximum value phase differences of antennas A₁ and A₂ and antennas A₂ and A₃:

Δφ₁₂=Δφ₁−Δφ₂

Δφ₂₃=Δφ₂−Δφ₃ (11)

it is possible to calculate the differences between the path lengths measured from the individual antennas to the transponder 2:

$$Δ {r}_{12} = {r}_{1} - {r}_{2} = {Δϕ}_{12} \cdot \frac{λ / 4}{2 π} \\ Δ {r}_{23} = {r}_{2} - {r}_{3} = {Δϕ}_{23} \cdot \frac{λ / 4}{2 π} \qquad ( 12 )$$

The target deviation angle determined respectively by an antenna pair results from the determined path differences:

$$sin {α}_{12} = \frac{{Δ}_{12}^{r}}{d} \\ sin {α}_{23} = \frac{{Δ}_{23}^{r}}{c} \qquad ( 13 )$$

On condition that r_{z}>>d, c, it can be assumed that sin α₁₂=sin α₂₃=sin α_{z}. If we now subtract the path difference Δr₂₃ determined by the antenna pair A₂ and A₃ from Δr₁₂:

Δr₁₂−Δr₂₃=sin α_{z}·d−sin α_{z}·c=sin α_{z}·(d−c) (14)

It is thus possible to determine the target deviation angle α_{z} as a function of the distance differences Δr₁₂ and Δr₂₃ determined by the two antenna pairs:

$$sin {α}_{z} = \frac{Δ {r}_{12} - Δ {r}_{23}}{d - c} \qquad ( 15 )$$

or to show it with the equations derived for the distance differences in the form

$${α}_{z} = arcsin ( \frac{{Δϕ}_{12} - {Δϕ}_{23}}{d - c} \cdot \frac{2 / 4}{2 π} ) \qquad ( 16 )$$

For unambiguous angle measurement there is likewise the restriction to the phase region Δφ₁₂−Δφ₂₃=±π. The maximum unambiguous angle that can be detected with this

$${α}_{z , end} = \pm arcsin ( \frac{λ}{8 \cdot ( d - c )} ) \qquad ( 17 )$$

is however no longer a function of the interval between two antennas but of the differential interval between the two antenna pairs d-c. This can be selected to be as small as required regardless of the antenna dimensions. It is thus possible to adjust the angular range for a target location to any value between ±90°.

Three-dimensional location can be executed according to FIG. 10. If we extend the system to include one or more further antennas A₄, A₅, which are positioned vertically above or below the horizontally arranged antennas A₁, A₂, A₃, three-dimensional location is possible. As with two-dimensional location on the one hand the azimuth 10 and on the other hand the elevation 11 of the transponder 2 are determined. It is thus possible to calculate the x-, y- and z-coordinates together with the measured distance r_{z}. The possible antenna location consisting of five antennas (A₁ to A₅) is illustrated according to FIG. 10. Here the antennas A₁ to A₃ are used to measure the azimuth 10. The antennas A₄, A₂ and A₅ are used to measure the elevation 11. The antennas are likewise designated by the reference character 3.

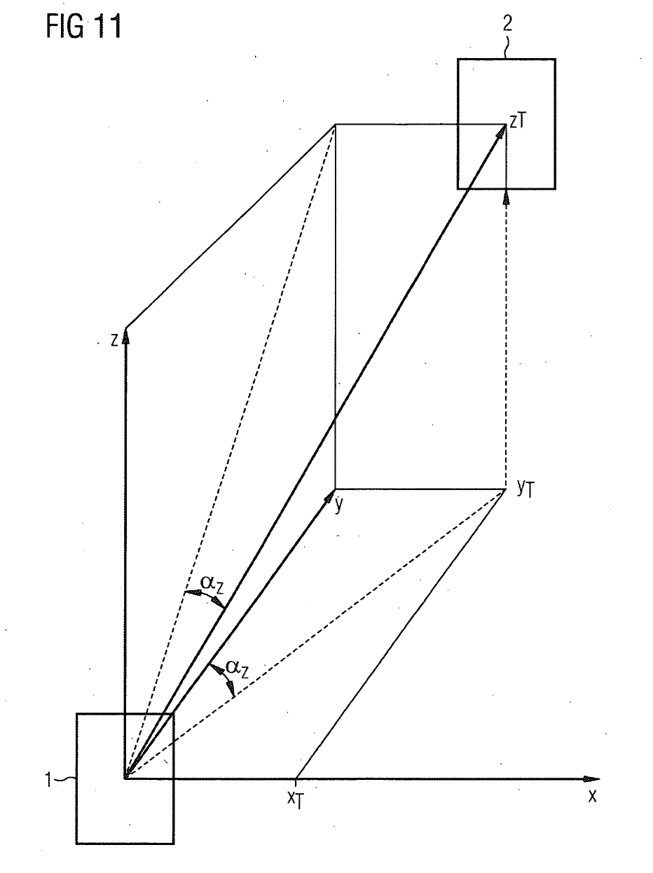

FIG. 11 shows a diagram of a base station 1 at the origin of an x-, y-, z-coordinate system. The main action direction of the base station 1 lies on the y-axis. The transponder 2 is located at an x_{T}, y_{T} and z_{T} position, which can be determined by means of the distance between the transponder 2 and the base station 1 and the two target deviation angles α_{z}.

1.-13. (canceled)

14. A radio-based system for the multi-dimensional location of a target object, comprising:
a base station with a plurality of antennas that transmits base signals and/or receives response signals;
a target object that receives the base signals and emits response signals;
a first facility detects one-dimensional of the distance from the base station to the target object; and
a second facility detections a deviation angle of the target object,
wherein the plurality of antennas include a first antenna and a second antenna arranged adjacently, and
wherein an interval is arranged between the adjacent antennas.

15. The radio-based system as claimed in claim 14, wherein the response signal is a modulated backscatter signal the received base signals with a modulation frequency to an antenna.

16. The radio-based system as claimed in claim 14, wherein the first facility determines a frequency interval between two maximum values in the baseband of the spectrum of a base signal transmitted with a simultaneously received response signal superimposed on it to an antenna,

17. The radio-based system as claimed in claim 14, wherein the second facility determines a distance from the target object to an antenna based on maximum value phase differences.

18. The radio-based system as claimed in claim 14, wherein the second facility determines distance differences from adjacent antennas to the target objects respectively based on a difference in maximum value phase differences.

19. The radio-based system as claimed in claim 14, wherein the second facility determines the deviation angle based on the ratio of distance differences of two adjacent antennas to the interval between the two adjacent antennas

20. The radio-based system as claimed in claim 14, wherein the distance between the base station and the target object is much greater than the interval between adjacent antennas.

21. The radio-based system as claimed in claim 14, wherein the interval of adjacent antennas is short.

22. The radio-based system as claimed in claim 14, wherein when more than two antennas are used, the differences between the intervals of adjacent antennas is small and greater than zero.

23. The radio-based system as claimed in claim 14, wherein the antennas are arranged along a horizontal line and/or along a vertical line.

24. The radio-based system as claimed in claim 14, wherein the target object is a transponder, RFID tag or radio-interrogatable sensor.

25. The radio-based system as claimed in claim 14, wherein the target object is passive or semi-passive.

26. A method for using a radio-based system for the multi-dimensional location of a target object, comprising:
detecting a distance from a base station to the target object, the base station having a plurality of antennas that transmit a base signal and a receives response signal, the target object receives the base signal and emits a response signal; and
detecting of a deviation angle of the target object,
wherein the plurality of antennas include a first antenna and a second antenna arranged adjacently, and
wherein an interval is arranged between the adjacent antennas.

27. The method as claimed in claim 26, wherein the determination of the deviation angle is based on the ratio of distance differences of two adjacent antennas to the interval between the two adjacent antennas

28. The radio-based system as claimed in claim 27, wherein the distance between the base station and the target object is much greater than the interval between adjacent antennas.
